(19) United States
(12) Patent Application Publication
(10) Pub. No.: US 2014/0120977 A1
(43) Pub. Date: May 1, 2014

(54) METHODS AND SYSTEMS FOR PROVIDING MULTIPLE COORDINATED SAFETY RESPONSES

(71) Applicant: DAVID AMIS, Durango, CO (US)

(72) Inventor: DAVID AMIS, Durango, CO (US)

(21) Appl. No.: 13/660,023

(22) Filed: Oct. 25, 2012

(51) Int. Cl. H04W 4/22

(52) U.S. Cl. 455/521

(57) ABSTRACT

The disclosure generally relates to methods and systems for providing multiple coordinated safety responses. In an exemplary embodiment, the disclosure relates to notifying multiple persons who are within a vicinity of a victim, and instructing those persons to provide various safety responses at various frequencies, where the frequency of the response can be related to the closeness of first responders to the scene. The invention uses a safety force multiplier that frustrates, confuses, scares, and/or distracts a potential perpetrator by delivering multiple responses to a scene.

### CROSS-REFERENCE TO RELATED APPLICATIONS

The present application is a Continuation-in-Part of U.S. Non-Provisional patent application Ser. No. 12/862,117, filed on Aug. 24, 2010, which claims the benefits of U.S. Provisional Application No. 61/236,265, filed on Aug. 24, 2009, the contents of which are hereby incorporated by reference in its entirety. The present application further claims the benefit of U.S. Provisional patent application No. 61/551,877, filed on Oct. 26, 2011. The contents of each of the afore-mentioned patent applications are hereby incorporated by reference in their entireties.

### BACKGROUND

1. Field of the Invention

The present invention relates generally to the field of providing safety systems that includes a force multiplier and an algorithm that drastically increases the effect of emergency aid by combining multiple safety acts, responses, or systems.

2. Description of Related Art

We are constantly reminded of the need for personal safety in today's society. All too often in the news we hear of missing persons and the dramatic searches which ensue. For each heroic story of a “just-in-time” rescue of a person who is abducted, lost, in a threatening situation, or in need of emergency medical care, there are many more personal dramas which unfortunately end in tragedy. It follows that immediate notification of an emergency situation and a prompt response from police, paramedics, fire department, or another service organization are essential for the well-being of the individual.

Today's technology provides us with public services such as the 911 telephone number for rapidly summoning emergency help if we are able to access a telephone, dial the number, and communicate our location. However, these services fall short in the case of a young child, a mentally incompetent or medically incapacitated person, someone lost in the woods, or the victim of an abduction or kidnapping. These situations necessitate a security system that travels with the individual, is not limited in range, is able to define and signal an emergency situation without human intervention, and identifies the individual's location. Such a system would provide protection to the individual and peace of mind to those responsible for his or her care and well-being.

Current available technology does not address the case of an individual who is helpless in an emergency situation where information is required so that the appropriate authorities can respond quickly and efficiently to a distress signal generated by the individual. Providing personal safety for persons at risk demands a fully automated and responsive system for summoning assistance.

Additionally, children are abducted daily in our society by strangers, family and known people. Police response frequently occurs hours after such abduction. In many cases the children are harmed and in some cases they are killed. There are child-tracking devices commercially available which are capable of monitoring the location of the missing child but there are no known commercially available devices that monitor the children's' activities and surroundings that may indicate danger is imminent. These commercially available devices cannot monitor the movements of a person with the intent to abduct or harm a child as the person approaches the child. Further, these devices cannot warn the child to run away and seek safety.

In addition, current personal GPS devices that are worn or carried allow an individual's location to be tracked and, in some cases, allow help to be summoned in an emergency by transmitting the current location of the individual to providers of emergency services. However, these systems fail to convey potentially valuable information such as a voice message, an image and/or a movie/video. For example, this information could be useful in identifying a criminal suspect or for determining what type of emergency response (e.g., police, ambulance, and fire) is appropriate. Another drawback of current systems is that they fail to integrate other common portable devices, such as cellular phones and PDAs (Personal Digital Assistants). Having one more electronic device to carry reduces the likelihood that an individual will use it.

Therefore, there is a need for systems and methods that overcome the deficiencies of traditional personal safety signaling and alerting devices.

### SUMMARY

In one embodiment, the disclosure relates to a method of providing multiple safety responses, comprising: receiving an alarm signal at a remote monitoring center from a first mobile device; determining, by a processor, a location the first mobile device; determining, by the processor, at least one nearby mobile device that is within a pre-determined distance of the location of the first mobile device; and transmitting, by the remote monitoring center, an instruction message to the nearby mobile device, wherein the instruction message includes a response type and a first response frequency at which the response is to be delivered.

In another embodiment, the disclosure relates to a method of coordinating multiple responders to provide safety services, comprising: receiving an alarm signal at a remote monitoring center from a first mobile device; determining, by a processor, a location the first mobile device; determining, by the processor, at least one nearby mobile device that is within a pre-determined distance of the location of the first mobile device; determining, by the remote monitoring center, a first location of a responder; and transmitting, by the remote monitoring center, an instruction message to the nearby mobile device, wherein the instruction message includes a response type and a first response frequency based on the first location of the responder.

In still another embodiment, the disclosure relates includes a multiple response algorithm which coordinates the types, combinations and timing of the 911-related responses to match the type of crime, the perpetrator (with actual or estimated profiles stored on the security network, or accessed via the security network), the situation, the availability of first responders and other forms of aid such as safety networks, volunteers, fire departments, the public, etc., and the user themselves.

In still another embodiment, the disclosure relates to a system of coordinating multiple responders to provide safety services, comprising: a processor configured to receive an alarm signal from a first mobile device; a database coupled to the processor, the database including a list of member mobile devices; a location determining means coupled to the processor and configured to identify at least two member mobile devices from the list of member mobile devices that are within a predetermined distance of the first mobile device; and an instruction generator coupled to the processor and configured to transmit first response instructions to the identified member mobile devices, wherein each identified member mobile devices receives a different response instruction.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic of a personal safety and tracking system in accordance with an embodiment of the present invention;

FIG. 2 is an exemplary illustration of a personal safety device in accordance with an embodiment of the present invention;

FIG. 3 is a flowchart illustrating the steps of providing assistance to a user in accordance with an embodiment of the present invention;

FIG. 4 is an illustration of an exemplary dispatch interface in accordance to certain embodiments of the invention; and

FIG. 5 is a block diagram of a personal safety device system in accordance to certain embodiments of the invention.

### DETAILED DESCRIPTION

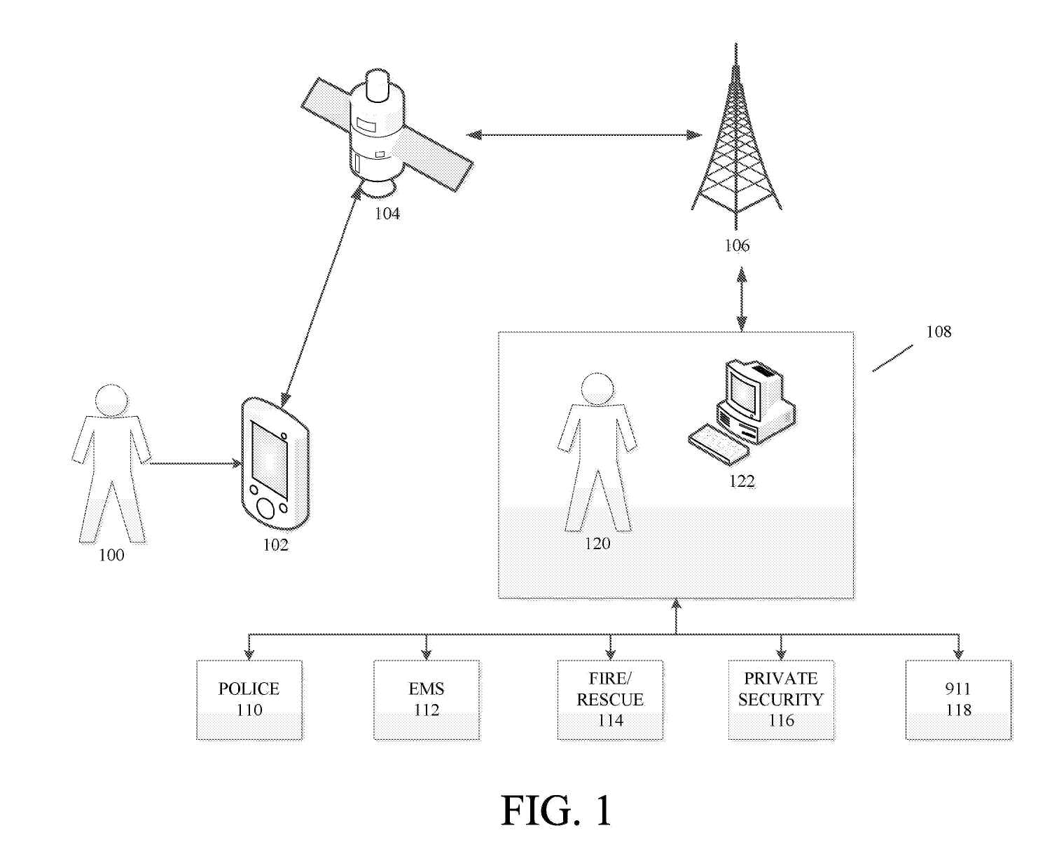

FIG. 1 is a schematic of a personal safety and tracking system in accordance with an embodiment of the present invention. Referring to FIG. 1, the personal safety and tracking system according to the present invention generally includes a personal safety device 102 which is located on or near the user 100. In a preferred embodiment, the user 100 can be a person, such as a child, elderly person, disabled person, or a person living alone.

The personal safety device 102 can be a standalone personal safety device, or can be incorporated into a cellular phone, portable music player, keychain, pager, PDA, or other portable communication device. In another embodiment, the personal safety device 102 can be worn on the user 100, such as around the user's neck or as a wristband. In a preferred embodiment, the personal safety device 102 is a multi-function device that includes signal reception and transmission capabilities, and includes a cellular phone capability that allows the user 100 to communicate with a remote location. The personal safety device 102 is described in more detail in FIG. [xx].

The personal safety device 102 is configured to transmit an alarm signal to a satellite or global positioning system (GPS) which makes up a communications system 104. The communications system 104 is configured to identify the origination location of an alarm signal transmitted from a personal safety device 102. It should be appreciated by one skilled in the art that various types of locating and satellite systems, such as, but not limited to, LORAN-C or GLONASS, may perform the function of providing accurate position coordinates and may be substituted thereof. Hence, the present invention should not be construed as limited to the communications system 104.

In another embodiment, the personal safety device 102 does not employ GPS for communications with a remote monitoring center 108, but rather utilizes Earth-based telecommunications towers, such as communication tower 106, which are part of the current wireless communications and cellular grids. In this embodiment, the GPS only provides latitude and longitude coordinate determining means to locate the global position of the user 100 via the personal safety device 102.

The communications system 104 further provides a means for data and voice communications between the personal safety device 102 and a remote monitoring center 108. In an embodiment, a communication tower 106 receives an alarm signal from the communications system 104 and routes it to the remote monitoring center 108. Multiple remote monitoring centers 108 are scattered throughout the country, so that an alarm signal sent from a personal safety device 102 is routed to the nearest remote monitoring center 108.

The communications system 104 provides a means for data and voice communications between the personal safety device 102 and a remote monitoring center 108. The communications system 104 may be any conventional cellular or wireless communications system. It should also be appreciated by one skilled in the art that other types of communication devices such as satellite transceivers or any other two-way wireless communication system may perform the function of the communications system 104, and these may easily be substituted thereof. Hence, the present invention should not be construed as limited to communications system 104 as described herein.

The remote monitoring center 108 serves as a go-between the user 100 and various service providers, such as police departments 110, emergency medical service (EMS) providers 112, fire and rescue departments 114, private security providers 116, and 911 emergency centers 118, as well as other users who are connected to the network and/or opted-in or designated as contacts for the user 100.

In an embodiment, several emergency response protocols can be initiated in parallel, in a pre-determined sequence, or in a random sequence, to exacerbate, frustrate, confuse, scare, or distract a potential perpetrator. The system is coined Multiple Response 911 (hereinafter, “MR-911”), and it enhances the effect of any safety system including traditional 911 systems and methods by raising doubt in the mind of a potential perpetrator as to who, what, why, and how a security response is occurring, by increasing both the speed, options, and variety of help, as well as by improving the situation of the user 100, as far as their mental state and confidence level.

When there are multiple “911” or security-type responses, this means the perpetrator has to deal with multiple goals or task.

But the key action of MR-911 is that it creates a lot of uncertainty for a perpetrator. For example, a hardened criminal may know that police take 5-10 minutes to arrive and he may further know their likely route of approach so that he can watch it and essentially contain that threat by putting it into known parameter, thinking to themselves, “I′ll see them coming” or “I′ve got at least five minutes”. MR-911, creates too many variables for him to deal with and further adds uncertainty. While police response times may be predictable (although more in perception than in reality), a father or loved one coming to help is a very unpredictable situation for the perpetrator as regards to timing, capability, rationality (most would expect a father to be fairly angry and not necessarily rational, thus increasing the downside risk to a perpetrator—the worst case with law enforcement is normally incarceration, however, with an angry father, it is not predictable.

More importantly, MR-911 can include an air response, good Samaritans, UAV's, neighbors, security companies, cameras that are turned on, house lights that are turned on, passing cars that use their mobile cameras, and more. When there is a minimum of three 911-type responses, which can include everything from a beeping noise to an armed officer, the perpetrator quickly loses his ability to estimate and manage the risk of his crime.

Another benefit to MR-911 is that it will increase apprehension rates by confusing, disorienting and generally putting the perpetrator in a situation where they cannot predict or manage the number, type, or degree of responses they must deal with. If, for example, a neighbor shines a light in the window, this can cause a delay in the crime. When a friend knocks on the door, the perpetrator may try to leave and be further delayed or perhaps observed clearly. Then when law enforcement or private security arrive on the scene, they benefit from the delay, the additional information (i.e., such as a good description) and anything else that has happened from the initial traditional and non-traditional responses.

The 911 Force Multiplier utilizes three or more responses of a different nature, which therefore leads to a multiple of variables that the perpetrator must deal with. For example, in a non-limiting example, the system includes six responses, questions, and issues that accompany each for a perpetrator in the middle of a crime:

(1) 911 is called: How long do I have before the police arrive?
(2) A red light is flashing: what does it mean? How do I turn it off?
(3) A safety network has been contacted: who is coming? How close are they?
(4) A neighbor shines a light in the window: who is that? Someone knows we're here. What are they going to do? If the police weren't called already, are they going to call the police?
(5) A speaker is relaying “evidence collection has begun . . . ”: what evidence? Does this mean they'll catch me? Should I not touch that device?

For example, when dealing with following types of crimes and situations, different MR-911 combinations with varying intensity, tempo, and delivery times will prove most useful.

Date rape inside the user's home: neighbors would be contacted to knock on the wall or come over, which may stop or delay the crime.

Robbery on a city street: localized cameras could be activated or store managers could be contacted to witness the crime with cameras which will provide a long term deterrent effect as robbers would soon learn that public places had coordinated camera and other responses.

Violent Assault in a building: building lights could be turned on and, off, immediate response would be needed so local volunteers might rush to the scene or occupants could be asked to film the access areas which would help to deter and delay that and any future crimes.

Gang Rape of a College Student: playing a recording on the user's speakerphone clarifying what is and is not legal might impact the thinking process of young men who are confused about what is legally or morally acceptable and thus deter or decrease the crime.

In each of these non-limiting examples, there would be multiple response but the above gives an idea of the how the MR-911 system can adjust to maximize the impact on a particular perpetrator, or crime type.

In an embodiment, the speed of an emergency response delivery on the scene of the user 100 is drastically increased, as the remote monitoring center 108 can notify a nearby person, such as the user's neighbor immediately upon receiving an alarm signal from the user 100. The neighbor can, for example, bang of an adjoining wall, knock on the user's door, shine a flashlight into the user's home, honk their car horn outside of the user's home, and/or call the neighbor's home or mobile phone.

Furthermore, the level of response provided by the neighbor can be dictated by the remote monitoring center 108. For example, if law enforcement officials are 10 minutes away, the neighbor can lightly bang on the wall, and when first responders are 30 seconds away, the neighbor can bang heavily on the wall. The level of response provided by the neighbor can increase as the first responders near. Such action serves to delay and distract a perpetrator, and when first responders arrive the perpetrator may be focusing its attention on the banging sound instead of further committing a crime or harming the user 100.

In an embodiment, multiple nearby persons are simultaneously notified, and each is instructed to person a certain response or act by the remote monitoring center 108. The remote monitoring center 108 can determine if any members of its security network are within a pre-determined vicinity of the user 100, based on located-based sensing technologies utilizing the members' personal safety devices. The remote monitoring center 108 can then transmit a message to each of the identified nearby persons, where the message includes directions or a route to the user 100, as well as instructions on how to respond.

In an embodiment, each identified nearby person is given a different act to perform, at a different level, tempo, beat, or frequency. As the distance of the first responders to the user 100 decreases, the intensity of the acts performed by the identified nearby persons can increase. The remote monitoring center 108 can continually transmit new instructions to the identified nearby persons based on the location data of the first responders.

In another embodiment, depending on the status of the first responders, the action of the neighbor and/or others nearby can vary. Also, alternative, more advanced responses such as UAV's can be deployed to the scene if first responders are stuck in traffic, or cannot reach the scene in a timely fashion. For example, unmanned helicopters controlled from the remote monitoring center 108 can be deployed to record a scene from a safe distance, transmit audio messages/warnings, as well as deploy deterrents and firepower if needed.

In conjunction with notifying nearby persons to assist the user 100, the personal safety device 102 can emit a notification that first responders are en route, either through an automated message or a live message spoken by a dispatch operator 120.

In an embodiment, the remote monitoring center 108 is staffed by one or more dispatch operators 120 and includes a communication and dispatch system 122 which may include a telephone system, one or more data modems, a computer system, and one or more display consoles. The communication and dispatch system 122 comprises means to store and access communications information, a user database, an emergency services database, map display information, and unit identifier and alarm status display information. The communication and dispatch system 122 further comprises one or more data-to-voice switches and has remote activation capability, plotting algorithms, boundary monitoring alarm features, and the capability to store and retrieve historical data as well as data related to the user 100 or the personal safety device 102. In a preferred embodiment, display console displays the alarm signal origination location, the user identification, and an alarm code, as described in more detail in FIG. [xx] below. A number of suitable map programs incorporating many of these features are commercially available and suitable for use with the present invention.

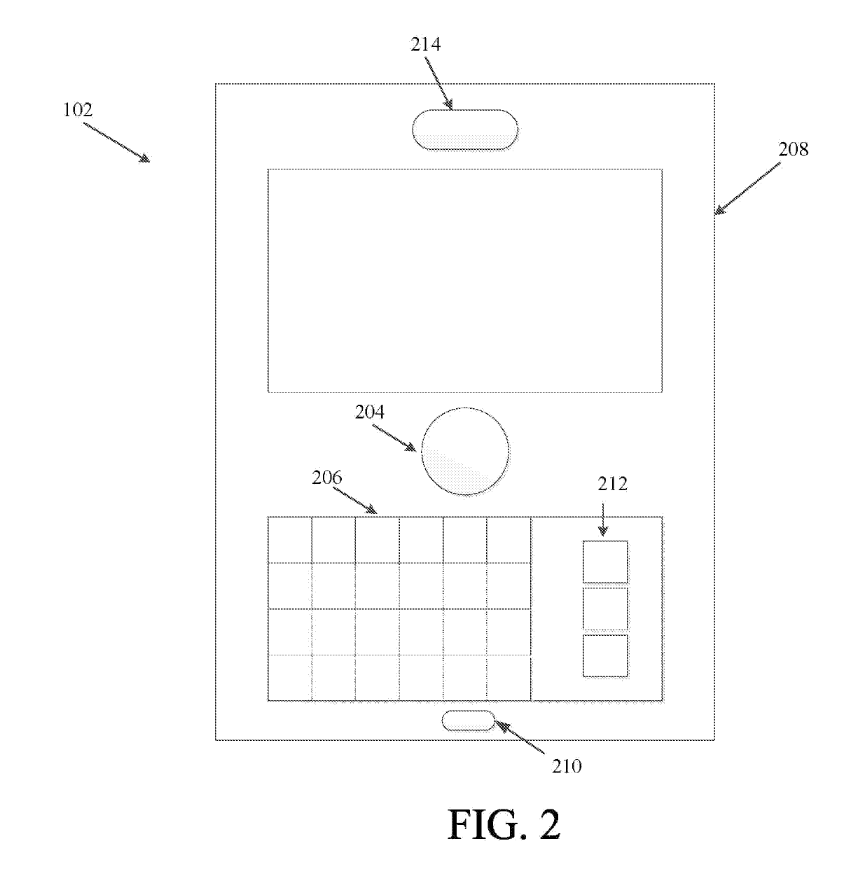

FIG. 2 is an exemplary illustration of a personal safety device in accordance with an embodiment of the present invention. A personal safety device 102 in one embodiment can be hand-held and/or wearable with a form factor similar to that of a portable electronic device such as (but not limited to) a cellular phone, digital music player or digital camera. In one embodiment, the housing is a special color that warns criminals of its special purpose. A GPS receiver or other geographic location determination device (e.g., GSM transceiver) is integrated with the personal safety device 102 and can be used to determine the location, speed and direction of travel of a personal safety device 102 user.

The personal safety device 102 includes a display 202 (e.g., liquid crystal, light emitting diode, plasma, or other suitable display) which can be used to display status information and messages. By way of a non-limiting example, status information could include location information, battery life, an indication of whether or not the personal safety device 102 is within range of a receiver, paging/e-mail messages, caller identification, music selections, images, games, and information entered from keypad 206.

The keypad 206 (e.g., numeric or alphanumeric) can be used to place phone calls, send pager/e-mail messages, play games, and otherwise allow a user to interact with the device. The keypad can be a full QWERTY keyboard or a standard 10-key numeric keypad. Specialized ergonomic controls to operate integrated modules such as a camera, a digital music player, game player, and/or cellular phone can be located on the keypad or elsewhere on the device and are fully within the scope and spirit of the present disclosure.

In an embodiment, special signaling keys 212 are positioned on the personal safety device 102. The signaling keys 212 are each specific to a different service provide, such as, but not limited to, police departments, EMS providers, fire and rescue departments, private security providers 116, and 911 emergency centers 118. Thus, the user 100 has a one-touch access to send an alarm signal to a specific provider.

Furthermore, the personal safety device 102 includes a panic button 204, which can be button, switch, or other-touch sensitive device can be used to activate a safety feature of the personal safety device 102. By way of a non-limiting example, the user can depress the panic button 104 once to begin recording sound through microphone 210 and optionally begin recording still or moving images (e.g., MPEG-4) through a digital camera having lens 214. If the user believes that they may be in danger, additionally pressing the panic button 104 one or more times in succession can activate an emergency channel wherein the user's current location, speed, direction of travel and some or all of the collected sound and/or image information can be transmitted (e.g., as one or more data packets on a mobile telephone, such as a cellular telephone, a mobile telephone network or a mobile LAN or other wireless network as described above) from the personal safety device 102 to a remote monitoring center 108 wherein help can be automatically summoned on behalf of the user 100.

In another embodiment, the panic feature can be activated with a voice command or by a sound, or by applying pressure to the surface of the personal safety device 102. For example, the personal safety device 102 can be programmed to automatically send an alarm signal to the remote monitoring center 108 upon the user saying a particular word or panic phrase. The personal safety device 102 can include voice recognition software so that only a registered user's voice can activate the panic feature. In another embodiment, a family may choose to register the voices of all family members (e.g. parents, children, elderly grandparents) into the personal safety device 102 so that it can be activated by numerous family members.

In another embodiment, the personal safety device 102 includes a touch sensitive case 208 that can activate the panic feature upon application of a certain amount of pressure. When the user 100 exerts pressure in excess of a threshold amount, the panic feature is activated. This feature is especially useful in situations where the user 100 cannot speak or make sounds.

It will be appreciated that the present disclosure is not limited to any one particular method of activating the panic feature of the personal safety device 102. In one embodiment, the information can be encrypted and/or compressed prior to or during transmission. If the personal safety device 102 cannot reach the communication system 104 or the remote monitoring center 108 due to its being out of range or for some other reason, the personal safety device 102 will buffer the information and transmit the alarm signal once it is able to establish contact with the communication system 104.

In another embodiment, the personal safety device 102 can include a biometric identification device that can be used to authenticate its user. In one embodiment, the biometric identification device can be integrated into the panic button 204 or voice recognition system. Such biometric sensing devices can include, but are not limited to, finger print detection, voice recognition, retinal scanning (e.g., via the camera lens), blood or saliva analysis, facial feature analysis, vein analysis, and other suitable automated methods of recognizing a person. It will be appreciated by those of skill in the art that many more biometric identification methods which are not discussed herein are nonetheless fully within the scope and spirit of the present disclosure. In one embodiment, an offender may be required by their probation officer to periodically perform biometric identification to ensure that the offender has the device on their person.

In another embodiment, the personal safety device 102 can be integrated with other devices/form factors such as wristwatches, digital cameras, digital music players, PDAs, Pocket PCs or other suitable devices. In yet another embodiment, the personal safety device 102 can be integrated into a self-defense weapon. By way of a non-limiting example, the personal safety device 102 can be incorporated into a conducted energy weapon such as a stun gun or Taser, available from Taser International, Inc. of Scottsdale, Ariz. In such an embodiment, the panic button 204 could be ergonomically located on the weapon handle or integrated with the trigger mechanism. Likewise, the digital camera lens and microphone could be positioned on the weapon's barrel so that by pointing the weapon at an attacker, the weapon would be able to record the attacker's image and voice. This would allow the user to both summon help and provide a means for self-defense.

In another embodiment, a personal safety device 102 can include one or more tamper-resistant or tamper-proof bracelets, anklets, straps or harnesses to secure the personal safety device 102 to a person. In this way, small children who might be libel to remove and lose the personal safety device 102 will be thwarted. Similarly, a criminal probation program can use a personal safety device 102 to track an offender's location without the risk that the offender will remove the device. In one embodiment, if the personal safety device 102 is removed, the personal safety device 102 can automatically transmit a message to a relay to a remote monitoring center 108 indicating this event.

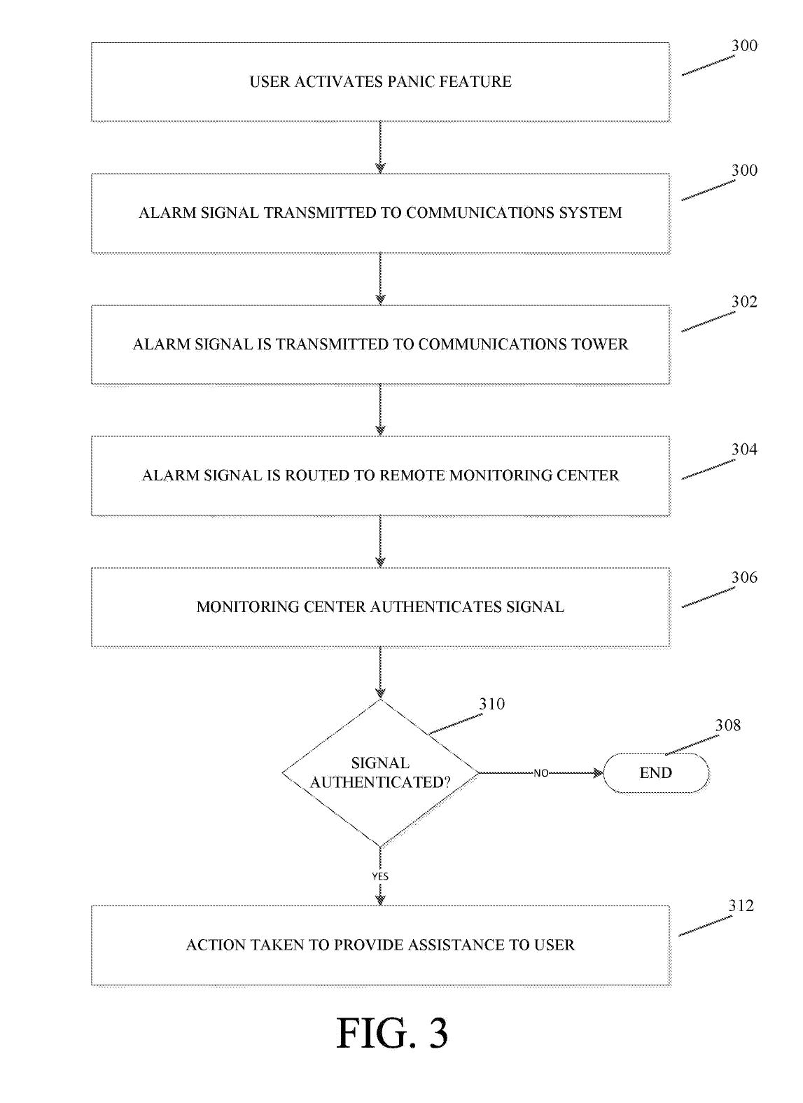

FIG. 3 is a flowchart illustrating the steps of providing assistance to a user in accordance with an embodiment of the present invention. Once a user 100 activates the panic feature of a personal safety device 102 in step 300, the personal safety device 102 transmits information including the individual's location to a communication system 104 in step 302 as described above.

After activation of one or more personal safety devices 102, an alarm signal is transmitted to one or more communication systems 104 in step 302 via one or more public or private networks. By way of a non-limiting example, a network can include one or more of satellite, cellular (e.g., CDMA, GSM, UMTS), local area wireless (e.g., Wi-Fi), Ethernet, token ring, Internet and ATM networks. In one embodiment, the communication system 104 can associate the transmitted location, speed, direction of travel, of the personal safety device 102, as well as the sound/image/video/movie information with time stamps and/or electronic signatures personal safety device 102 in order to provide a tamper-proof record of the information.

In another embodiment, the communication system 104 can be integrated into a network access point, such as a cellar base station, satellite uplink, or point-of-presence, such that personal safety device 102 information is made tamper-proof before it enters a network at large. Multiple communication systems 104 can be organized in clusters or grids to provide automatic load balancing and fail-over as is well known in the art wherein if one communication system fails or is busy, a second communication system can pick up where the first one left off. The communication systems can share a database management system (DBMS) to persist the information received from personal safety device 102.

In step 304, the alarm signal is transmitted from the communications system 104 to a communication tower 106 that is within the closest proximity to the GPS coordinates of the portable safety device 102. In an embodiment, the communication system 104 compares the GPS coordinates from the portable safety device 102 with the coordinates of various communication towers stored in a database (either locally on the communications system 104 or remotely).

Next, in step 306, the alarm signal is routed from the communication tower 106 to a remote monitoring center 108. In an embodiment, the remote monitoring center 108 determines at step 310 if the alarm signal has been sent from an authentic or registered user or personal safety device. In embodiment, the alarm signal may be encrypted, and requires a decryption key that is located on the communication and dispatch system 122 at the remote monitoring center 108. In another embodiment, the alarm signal can include identification information from the user 100 and/or the personal safety device 102 that can be compared to stored information on a database located on the communication and dispatch system 122 at the remote monitoring center 108.

If the alarm signal is determined to be fraudulent, or sent from an unregistered or unverified personal safety device, the process ends and no further action is taken by the remote monitoring center 108. However, if the alarm signal is verified, then the remote monitoring center 108 initiates an appropriate response at step 312.

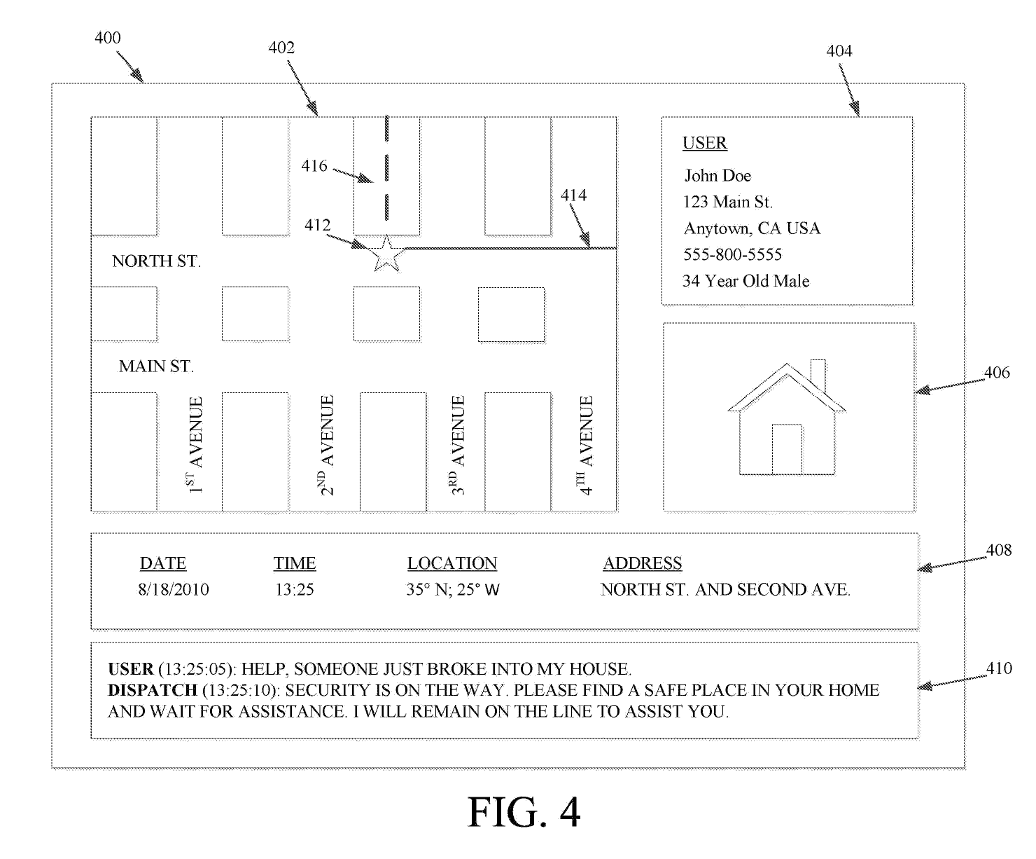

At this stage, a dispatch operator 120 is presented with information related to the user 100 and/or the personal security device 102 as further described in FIG. 4. The dispatch operator 120 can be a trained response provider, and may be former law enforcement personnel, 911 operator, or other person with an appropriate background and training in emergency and disaster response.

The dispatch operator 120 can assist the user 100 and provide a number of services, such as patching the user 100 to an emergency response provider, and staying on the call with the user 100 until help has arrived at the user's location. Furthermore, the dispatch operator 120 can act as a go-between the user 100 and a 911 center in the event that the user 100 is uncomfortable with directly dialing 911 in the absence of a certain emergency or a threat. In another embodiment, the dispatch operator 120 can be patched directly to a speaker on the personal safety device 102 and can announce that emergency response is on the way to the user's location. This may help in deterring any real or potential threats, such as burglars, intruders, and attackers that may be in the vicinity of the user.

In one embodiment, the communication and dispatch system 122 can allow interaction with a personal safety device 102 user through one or more communication channels. This interaction can be accomplished using any number of network protocols and data formats, including but not limited to IP, UDP, TCP/IP, HTTP, HTTPS, POP, VoIP, SOAP, XML, or any other suitable standard or non-standard format/protocol. In one embodiment, a “Contact” button allows a text, voice or video message to be sent to a personal safety device 102. A “Send Help” button allows the dispatch operator 120 to issue a command to dispatch emergency services to the user 100. Finally, the “Configure” button allows commands to be sent to a personal safety device 102. By way of a non-limiting example, such commands can include the ability to remotely unlock a tamper-resistant or tamper-proof bracelet or anklet that secures the personal safety device 102 to a user, the ability to remotely enable/disable the personal safety device 102 “Panic” button, and the ability to remotely enable/disable any other features of the personal safety device 102.

In addition, the dispatch operator 120 can activate the camera 214 on the personal safety device 102 and is able to see the scene at the user's location. In another embodiment, the communication and dispatch system 122 can record any images and video transmitted from the personal safety device 102 so that this evidence can be reviewed and analyzed by authorities if needed at a later time.

In another embodiment, upon receiving information from a personal safety device 102, the communication system 104 and/or remote monitoring center 108, in addition to contacting the emergency response systems, can also automatically contact one or more other clients (e.g., a child's parents, a friend or spouse, an employer, etc.). The notification can take many forms including, but not limited to, an electronic message sent over the one or more networks, an automated voice message sent via a telephone network or via VoIP, e-mail message, an automatically placed 911 call, a facsimile, and/or a pager message. The notification can include a user's current location, direction of travel, speed, and/or voice/image/video/movie data recorded by the personal safety device 102. This embodiment is useful if the user 100 is a child or elderly person, and a parent or guardian wishes to receive a notification when the panic feature is activated by the user 100.

In one embodiment, the notification delivery can be escalated automatically if an acknowledgement of its receipt is not received by the communications system 104 and/or remote monitoring center 108. For example, if an electronic message is sent but is not acknowledged within a certain time frame by a parent or guardian, the relay can attempt to automatically contact the parties through alternate and/or higher priority paths (e.g., via e-mail, telephone, etc.) until a confirmation that help is on the way is received.

FIG. 4 is an illustration of an exemplary dispatch interface in accordance to certain embodiments of the invention. The dispatch interface 400 visually depicts the path of a personal safety device 102 on a satellite or street map display 402 as well as a projected path based on the current direction and travel speed of the personal safety device 102. This allows the dispatch operator 120 to quickly ascertain where a user 100 with a personal safety device 102 is and where they might be going. In addition, the dispatch interface 400 provides the ability to playback images/movies/videos and sounds that were recorded on the personal safety device 102 at given geographic locations in the audio/visual display 406. The audio/visual display 406 can include controls for the dispatch operator 120 to pause, fast forward, rewind, slow down, or take a snapshot of the audio or visual data that is being transmitted from the personal safety device 102.

Besides providing this information, the dispatch interface 400 permits messages to be sent to the personal safety device 102 (e.g., a page or voice message) as well as configuration information which can control feature activation on the personal safety device 102. The dispatch interface 400 also has the capability of configuring escalation strategies and communicating and coordinating between various emergency response providers.

By way of a non-limiting example, the dispatch interface 400 can include one or more of the following: 1) a dispatch interface 400 (e.g., rendered with HTML); 2) an ability to respond to sounds and/or voice commands; 3) an ability to respond to input from a remote control device (e.g., a mobile communications device, such as a mobile telephone such as a cellular telephone, a PDA, or other suitable remote control); 4) an ability to respond to gestures (e.g., facial and otherwise); 5) an ability to respond to commands from a process on the same or another computing device; and 6) an ability to respond to input from a computer mouse and/or keyboard. This disclosure is not limited to any particular dispatch interface 400. Those of skill in the art will recognize that many other dispatch interface 400 embodiments are possible and fully within the scope and spirit of this disclosure.

In one embodiment, dispatch interface 400 can include a location history display 408 that contains a history of where a user has been. Each row in the list can include a date and time stamp for a location in latitude, longitude, and altitude, and the approximate street address. By default, the list can be automatically sorted so that the most recent information is at the top of the list. Selection of a row in the list can cause the location to be displayed in the map. As seen in FIG. 4, The street map display 402 shows the user's current location “*” 412, where user has been “solid line” 414, and where it is projected that the user is going “dashed line” 416. In one embodiment, the user's projected path can be based on the user's current direction, speed and prior location(s). The street map display 402 can be displayed as a street map, a satellite image, or an overlay of a street map on a satellite image. By default, a map of the user's current location is displayed and refreshed each time new location information is received by from the communication system 104. If the user 100 has activated the panic button 204, the relevant row in the location history display 408 can be displayed in red or otherwise highlighted to draw attention to it.

The dispatch interface 400 further includes a text display 410 which transcribes the communication between the user 100 and the dispatch operator 120. This text is stored in a database along with the audio/video recording as described above and can be retrieved for later review and analysis.

Furthermore, the dispatch interface 400 includes a user information display 404 which provides stored information related to the user 100. In an exemplary embodiment, the personal safety and tracking system is provided by a third-party provider, and requires users to registers for monitoring and safety services via a monthly or yearly subscription fee. When a user registers for the service, they provide the third-party provider with personal information which is then stored on a database on the communication and dispatch system 122. When an alarm signal is received from a user 100, a lookup is performed and the user's information is retrieved from the database and displayed to the dispatch operator 120 in the user information display 404.

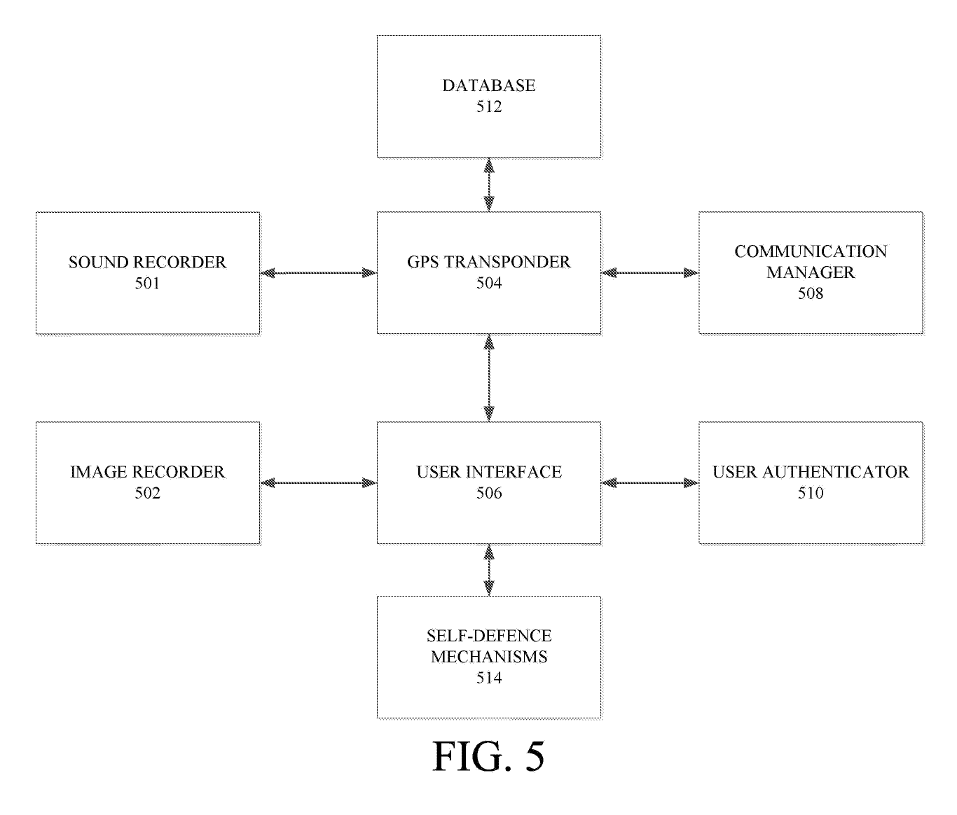

FIG. 5 is a block diagram of a personal safety device system in accordance to certain embodiments of the invention. Although this diagram depicts subsystems as logically separate, such depiction is merely for illustrative purposes. It will be apparent to those skilled in the art that the subsystems portrayed in this figure can be arbitrarily combined or divided into separate software, firmware and/or hardware modules. Furthermore, it will also be apparent to those skilled in the art that such modules, regardless of how they are combined or divided, can execute on the same computing device or can be distributed among different computing devices connected by one or more networks or other suitable communication means.

System 500 has an open architecture that allows for infinite expandability. The system is composed of one or more modules that implement a common communication mechanism. Component communication can be facilitated through a logical message bus or other paradigm that allows modules can send and receive asynchronous messages. In one embodiment, the message bus can be based on the JMS API available from Sun Microsystems, Inc. of San Jose, Calif. JMS is a messaging standard that allows application modules to create, send and receive messages. The message bus allows individual modules to take actions based on messages they receive and, likewise, to drive the action of other modules by sending messages. In one embodiment, a message can include a code identifying the source module of the message, the message type, and optional parameters. Such a flexible system allows for easy integration with new devices (e.g., PDAs, cell phones, music players, digital cameras, computer games) as these technologies evolve.

In one embodiment, the system 500 includes a sound recorder module 501 and image recorder module 502 that provide sound and image/movie/video recording capabilities, respectively. As with the other modules, modules 501 and 502 can provide services for capturing sound and images to other modules through a message interface. In one embodiment, the modules can store captured information in the database 512. In another embodiment, the modules can provide captured sounds/images/movies/videos in a message. Both modules can also implement hardware interfaces to allow any number of hardware devices (e.g., microphones, digital still/video cameras) to be easily plugged into the system. In another embodiment, modules 416 and 418 can be integrated into a single module.

The system includes a GPS transponder module 504 that can continuously or periodically receive location information from a compact GPS receiver or other device for determining geographic location and store said information in the database 512. In one embodiment, the database 512 can be any type of storage medium including floppy disks, optical discs, DVD, CD-ROMs, microdrive, and magneto-optical disks, ROMs, RAMs, EPROMs, EEPROMs, DRAMs, VRAMs, flash memory devices, memory stick, flash RAM, static RAM, non-volatile memory, magnetic or optical cards, nanosystems (including molecular memory ICs), or any type of media or device suitable for storing instructions and/or data.

The GPS transponder module 504 can receive messages that correspond to requests for current or historical position information and respond with the requested information. In one embodiment, the GPS transponder module 504 has a standard hardware interface, which allows any location determination device that conforms to the interface to provide location information to the system 500.

Communication manager module 508 can provide a standard interface for sending and receiving information over one or more communication mediums (e.g., cellular, satellite, Wi-Fi, pager, or other suitable medium). The communication manager module 508 can offer connected, connectionless, reliable and/or unreliable communication channels. In one embodiment, the communication manager module 508 implements a message interface that allows other modules on the message bus to access these services. By way of a non-limiting example, a module can send a message to: open a communication channel of with a given destination; send a message over the channel; register to receive a message when information is received on the channel; register to receive a message when information transmittal fails; and set transmission parameters such as retry count, message length, compression, and encryption. In one embodiment, the communication manager module 508 has a standard hardware interface, which allows any communication hardware that conforms to the interface to integrate with the communication manager module 508.

User interface module 506 can provide a standard interface for obtaining user input (e.g., keypad interaction, panic button, voice recognition, finger and hand articulation, etc.) and for providing visual, audio and other sensor output to the user. In one embodiment, the user interface module 506 implements a message interface that allows other modules on the message bus to access services related to input events and output functions. By way of a non-limiting example, a module can send a message to the user interface module 506 to register to receive input events from, for example, the keypad. Thereafter, whenever the user interface module 506 detects input from the keypad, it will send a message and any relevant data to modules that have registered to receive this input event. Likewise, a module can send a message to the user interface module 506 to cause output on a personal safety device, such as a display, speaker, vibrator or other output device. In one embodiment, the user interface module 506 has a standard hardware interface that allows any input/output hardware that conforms to the interface to provide authentication information to the user authenticator module 510.

A user authenticator module 510 can provide a standard authentication interface for the system components by hiding the particulars of the underlying authentication mechanism. This allows new and developing authentication mechanisms (e.g., finger print detection, voice recognition, retinal scanning, blood or saliva analysis, facial feature analysis, vein analysis, etc.) to be seamlessly adopted without requiring modifications to other system modules. In one embodiment, the user authenticator module 510 can accept requests to perform authentication and can respond with a determination of whether or not the authentication was successful. In one embodiment, the authenticator has a standard hardware interface, which allows any authentication hardware that conforms to the interface to provide authentication information to the authenticator.

It will be appreciated by those of skill in the art that many more biometric identification methods which are not discussed herein are nonetheless fully within the scope and spirit of the present disclosure. In one embodiment, an offender may be required by their probation officer to periodically perform biometric identification to ensure that the offender has the device on their person.

In an embodiment, the personal safety device 100 further includes various self-defense mechanisms to assist the user 100 to ward off, thwart, or fight back against attackers or intruders. For example, the personal safety device 100 can include a hidden blade which, upon activation by the user 100, is deployed from an edge of the personal safety device 100 and acts as a weapon. The personal safety device 100 can also include a pepper-spray or mace deployment system. Furthermore, the personal safety device 100 can be equipped with a high-intensity strobe light mechanism to emit blinding light to an attacker or intruder.

In another embodiment, the personal safety device 100 can be equipped with deafening alarm speaker to alert passer-bys and to scare off intruders. The speaker can emit static sounds, emergency sounds such as police sirens, the sound of gun shots, or the sound of a barking dog.

While the principles of the disclosure have been illustrated in relation to the exemplary embodiments shown herein, the principles of the disclosure are not limited thereto and include any modification, variation or permutation thereof.

What is claimed is:

1. A method of providing multiple safety responses, comprising:
receiving an alarm signal at a remote monitoring center from a first mobile device;
determining, by a processor, a location the first mobile device;
determining, by the processor, at least one nearby mobile device that is within a pre-determined distance of the location of the first mobile device; and
transmitting, by the remote monitoring center, an instruction message to the nearby mobile device, wherein the instruction message includes a response type and a first response frequency at which the response type is to be delivered.

2. The method of claim 1, wherein the alarm signal includes location information of the first mobile device.

3. The method of claim 1, wherein the first response frequency is based on a distance between the first mobile device and a responder.

4. The method of claim 1, wherein the processor transmits instruction messages to at least two nearby mobile devices.

5. The method of claim 1, wherein the instruction message includes the location of the first mobile device.

6. The method of claim 1, wherein the instruction message includes a route between a location of the nearby device and the location of the first mobile device.

7. The method of claim 1, further comprising transmitting, by the remote monitoring center, a second instruction message including a second response frequency different from the first response frequency.

8. A method of coordinating multiple responders to provide safety services, comprising:
receiving an alarm signal at a remote monitoring center from a first mobile device;
determining, by a processor, a location the first mobile device;
determining, by the processor, at least one nearby mobile device that is within a pre-determined distance of the location of the first mobile device;
determining, by the remote monitoring center, a first location of a responder; and
transmitting, by the remote monitoring center, an instruction message to the nearby mobile device, wherein the instruction message includes a response type and a first response frequency based on the first location of the responder.

9. The method of claim 8, further comprising, determining a second location of the responder by the remote monitoring center.

10. The method claim 9, transmitting, by the remote monitoring center, a second instruction message including a second response frequency based on the second location of the responder in relation to the nearby mobile device.

11. The method of claim 8, further comprising transmitting, by the remote monitoring center, a second frequency different than the first frequency to the nearby mobile device.

12. The method of claim 8, wherein the responder is selected from a group consisting of a law enforcement office, an emergency medical service provider, a fire fighter, and a private security provider.

13. The method of claim 8, wherein the nearby mobile device is registered with a database at the remote monitoring center.

14. A system of coordinating multiple responders to provide safety services, comprising:
a processor configured to receive an alarm signal from a first mobile device;
a database coupled to the processor, the database including a list of member mobile devices;
a location determining means coupled to the processor and configured to identify at least two member mobile devices from the list of member mobile devices that are within a predetermined distance of the first mobile device; and
an instruction generator coupled to the processor and configured to transmit first response instructions to the identified member mobile devices, wherein each identified member mobile devices receives a different response instruction.

15. The system of claim 14, wherein the first response instruction includes a frequency at which the first response instruction is to be delivered.

16. The system of claim 14, wherein the instruction generator is configured to continually transmit additional response instructions to the identified mobile devices, wherein the additional response instructions are different from the first response instruction.

17. The system of claim 14, wherein the processor is further configured to transmit a signal to a responder selected from a group consisting of a law enforcement office, an emergency medical service provider, a fire fighter, and a private security provider.

18. The system of claim 17, wherein the instruction generator is configured to transmit a response frequency based on a distance between the first mobile device and the responder.

19. The system of claim 14, wherein each identified member mobile device receives the first response instruction at a different time.

20. The system of claim 14, wherein the location determining means is configured to identify at least three member mobile devices.
